(19) United States
(12) Patent Application Publication
(10) Pub. No.: US 2019/0104321 A1
(43) Pub. Date: Apr. 4, 2019

(54) METHOD AND APPARATUS FOR ENCODING VIDEO USING INTRA REFRESH VIDEO ENCODING

(71) Applicant: ATI Technologies ULC, Markham (CA)

(72) Inventors: Wei Gao, Markham (CA); Ihab Amer, Markham (CA); Yang Liu, Markham (CA)

(21) Appl. No.: 15/720,771

(22) Filed: Sep. 29, 2017

(51) Int. Cl. H04N 19/61; H04N 19/31; H04N 19/23; H04N 19/105

(52) U.S. Cl. CPC H04N 19/61; H04N 19/105; H04N 19/23; H04N 19/31

(57) ABSTRACT

Encoding video data includes accessing video information, and encoding macroblocks in an intra refresh (IR) region of a video frame of the video information with restricted quantization parameters (QPs) based on QPs of macroblocks within at least one of a non-IR region of the video frame and a co-located region of a neighboring video frame in a temporal domain.

### BACKGROUND OF THE DISCLOSURE

Video encoding techniques modify an input video stream to produce a compressed output video stream. Compression techniques may include intra refresh (IR) encoding in which data to encode a video unit, such as, for example, frames, slices, and/or macroblocks, comes only from the present video frame or inter prediction encoding in which data to encode a video unit comes from the present video frame by referring one or more temporally adjacent video frames. Under certain conditions, inter prediction encoding allows for higher compression rates for a given output video quality by leveraging similarities between the temporally adjacent video frames. In contrast, IR encoding is based only on techniques for compressing still images, such as discrete cosine transform (DCT) encoding. Inter prediction encoding may incorporate techniques for compressing still images in combination with leveraging data from temporally adjacent video frames.

While encoding any digital video signal, in order to allow potential random access of the video signal, as well as for error resiliency reasons (for the decoder to be able to recover if an access unit of the bitstream is corrupted), a set of video units may be encoded as instantaneous decoder refresh (IDR) type, which means the units are forced as IR encoding units, rather than including any inter prediction encoding units. Typically, those forced IDR units come in patterns (once every preset number of frames and/or preset specific regions within a frame), the patterns representing IR regions within the frames.

IDR units, such as IDR macroblocks, allow random access of a video signal, as well as for error resiliency, but may cause noticeable visual artifacts, such as repetitive patterns, that harm the subjective quality of the video. In this manner, encoding that includes IDR type macroblocks may result in different quality of a reconstructed signal compared to encoding that does not include IDR type macroblocks. Subjectively noticeable visual artifacts from IDR type macroblocks are generally undesirable.

### SUMMARY OF THE DISCLOSURE

In accordance with one aspect of the present disclosure, a method of encoding video data includes accessing video information, and encoding macroblocks in an intra refresh (IR) region of a video frame of the video information with restricted quantization parameters (QPs) based on QPs of macroblocks within at least one of a non-IR region of the video frame, and a co-located region of a neighboring video frame in a temporal domain.

In some examples of this aspect of the disclosure, the restricted QPs of the macroblocks in the IR region are based on QPs of an intermediate area in the non-IR region of the video frame, wherein the intermediate area of the video frame is adjacent to the IR region of the video frame.

In the same or different examples of this aspect of the disclosure, the restricted QPs of the macroblocks in the IR region are based on QPs of the co-located region of the neighboring video frame in the temporal domain.

In the same or different examples of this aspect of the disclosure, the video frame includes the IR region of the video frame, a first intermediate area adjacent a first side of the IR region of the video frame, a second intermediate area in the non-IR region of the video frame adjacent a second side of the IR region of the video frame, and remaining portions of the non-IR region of the video frame. In at least some of these examples, the method further includes encoding a majority of macroblocks in the first and second intermediate areas of the non-IR region of the video with inter prediction encoding while forcing IR encoding on a distributed minority of the macroblocks, as well as encoding a majority of macroblocks in the remaining portions of the non-IR region of the video frame predominately with inter prediction encoding while forcing IR encoding on a distributed minority of the macroblocks.

In accordance with one aspect of the present disclosure, an apparatus for encoding video data, the apparatus comprising a video encoder logic structured to: access video information, and encode instantaneous decoder refresh (IDR) type macroblocks in an intra refresh (IR) region of a video frame with restricted quantization parameters (QPs) based on QPs of macroblocks within at least one of a non-IR region of the video frame, and a co-located region of a neighboring video frame in a temporal domain.

In some examples of this aspect of the disclosure, the video encoder logic is further structured to limit restricted QPs of the IDR type macroblocks based on QPs of an intermediate area in the non-IR region of the video frame, wherein the intermediate area of the video frame is adjacent to the IR region of the video frame.

In the same or different examples of this aspect of the disclosure, the video encoder logic is further structured to limit restricted QPs of the IDR type macroblocks based on QPs of the co-located region of the neighboring video frame in the temporal domain.

In the same or different examples of this aspect of the disclosure, the video frame includes the IR region of the video frame, a first intermediate area adjacent a first side of the IR region of the video frame, a second intermediate area in the non-IR region of the video frame adjacent a second side of the IR region of the video frame, and remaining portions of the non-IR region of the video frame. In at least some of these examples, the video encoder logic is further structured to encode macroblocks in the first and second intermediate areas of the non-IR region of the video frame predominately with inter prediction encoding while forcing IR encoding on a distributed minority of the macroblocks, encode macroblocks in the remaining portions of the non-IR region of the video frame predominately with inter prediction encoding while forcing IR encoding on a distributed minority of the macroblocks, and also structured to encode macroblocks in the first and second intermediate areas includes forcing IR encoding on a greater proportion of the macroblocks than when encoding macroblocks in the remaining portions of the non-IR region of the video frame.

In accordance with one aspect of the present disclosure, a non-transitory computer readable medium comprising executable instructions that when executed cause an integrated circuit (IC) fabrication system to fabricate one or more ICs that comprise: a video encoder logic structured to: access video information, and encode instantaneous decoder refresh (IDR) type macroblocks in an intra refresh (IR) region of a video frame with restricted quantization parameters (QPs) based on QPs of macroblocks within at least one of a non-IR region of the video frame, and a co-located region of a neighboring video frame in a temporal domain.

### BRIEF DESCRIPTION OF THE DRAWINGS

The embodiments will be more readily understood in view of the following description when accompanied by the below figures and wherein like reference numerals represent like elements, wherein:

FIG. 1 is a functional block diagram illustrating an example apparatus including video encoder logic comprising QP limiting logic, which may be associated with a processor, such as, for example, a graphics processing unit (GPU), to encode video data;

FIG. 2 is a functional block diagram illustrating an example apparatus including a central processing unit (CPU) and video encoder with QP limiting code residing in memory;

FIG. 3 is a conceptual illustration of a row-based IR region of a video frame surrounded by top and bottom intermediate areas;

FIG. 4 is a conceptual illustration of a row-based IR region of a video frame and a co-located region of a neighboring video frame in a temporal domain;

FIG. 5 is a functional block diagram illustrating an example of further detail of the operation of video encoder logic comprising QP limiting logic;

FIG. 6 is a flowchart of an example method for encoding video data while limiting QP to mitigate visual artifacts in the encoded video data;

FIG. 7A illustrates a video frame including an IR region, and FIG. 7B illustrates the video frame encoded without limiting QP, whereas FIG. 7C illustrates the video frame encoded while limiting QP to mitigate visual artifacts according to the techniques of FIG. 6;

FIG. 8 is a flowchart of an example method for encoding video data while forcing IR mode coding in areas outside an IR region of a video frame to mitigate visual artifacts in the encoded video data;

FIG. 9 illustrates a video frame video frame encoded while forcing IR mode coding in areas outside an IR region of the video frame according to the techniques of FIG. 8; and

FIG. 10 is a functional block diagram illustrating one example of an integrated circuit fabrication system.

### DETAILED DESCRIPTION OF EMBODIMENTS

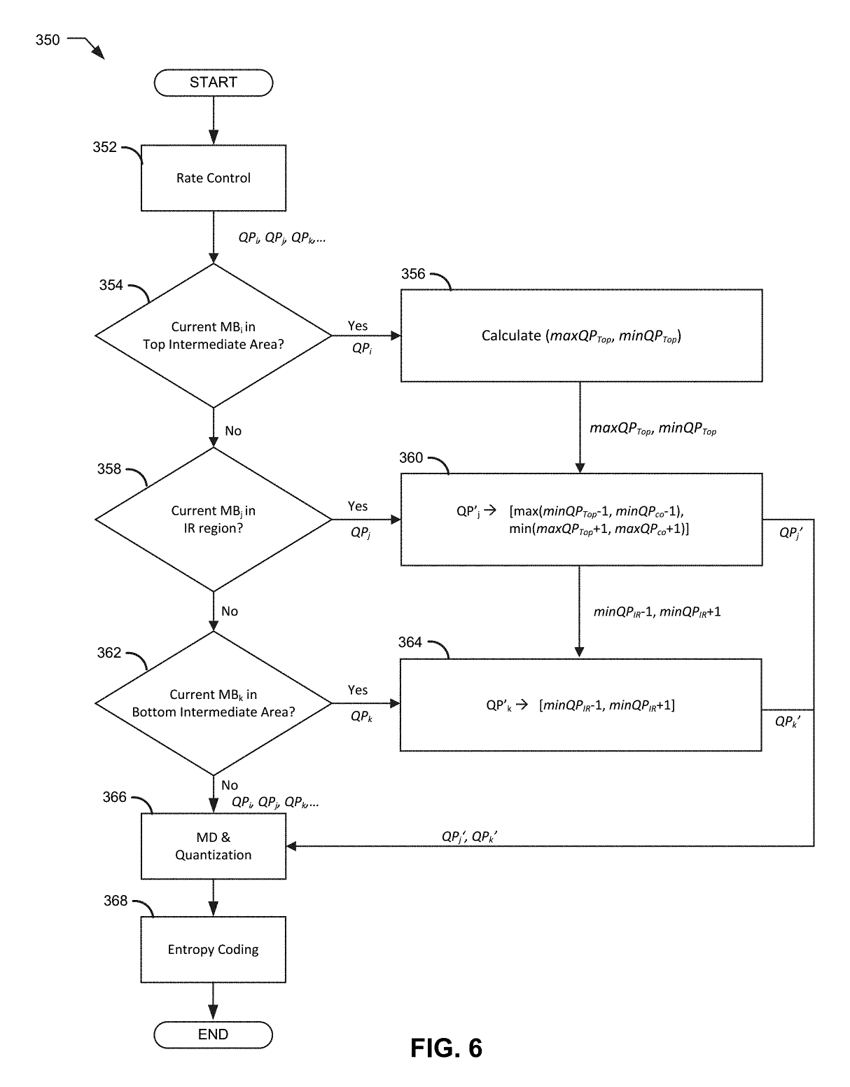

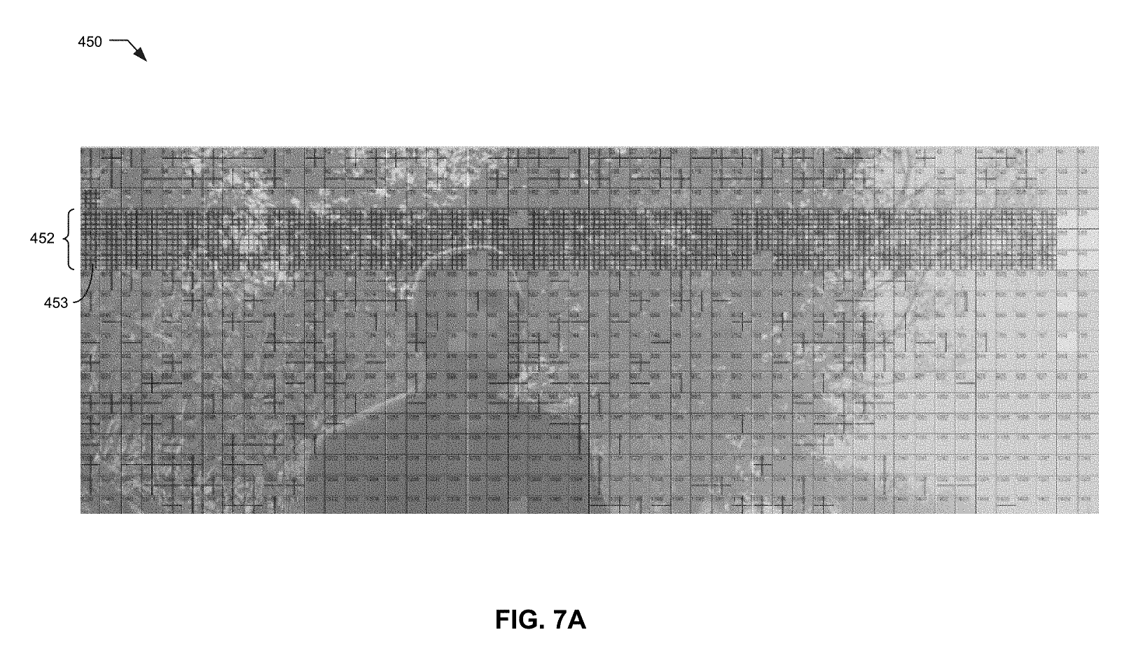

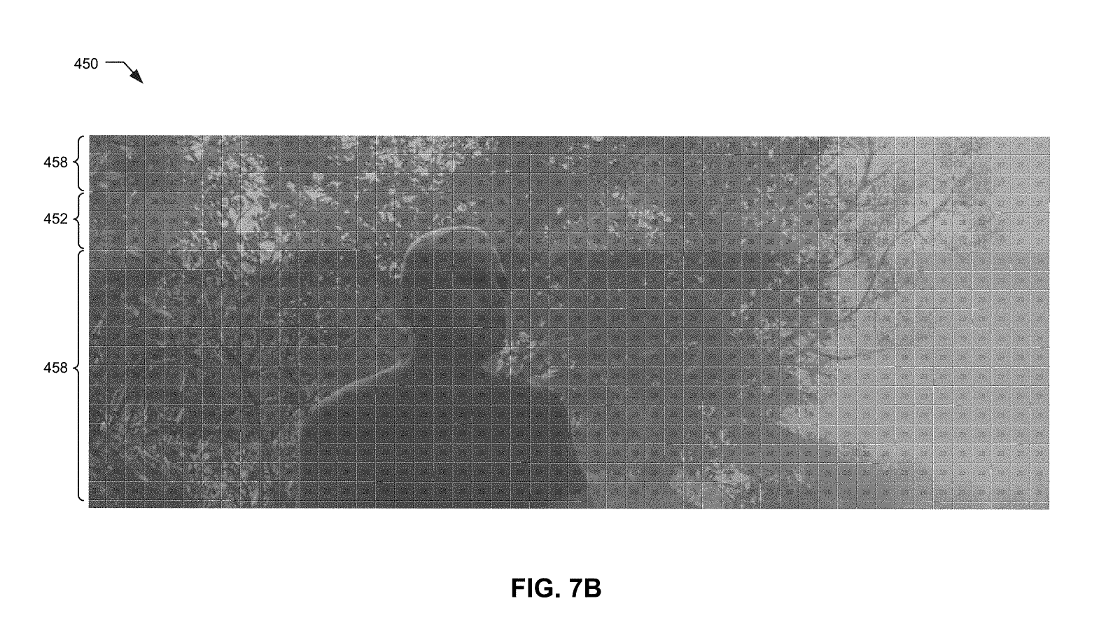

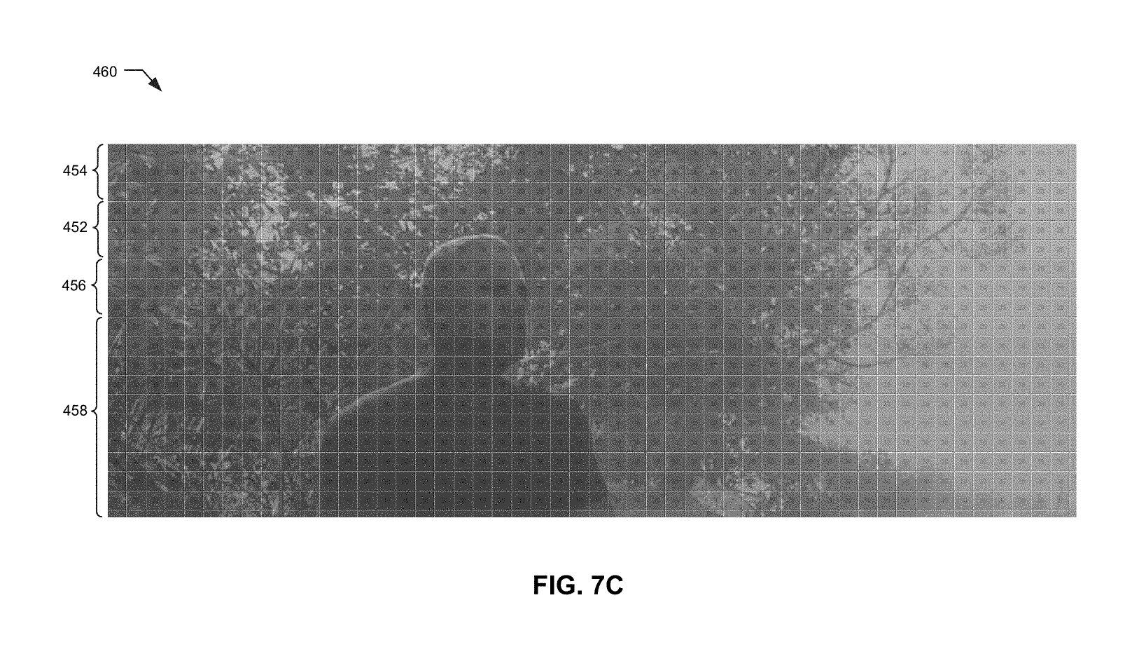

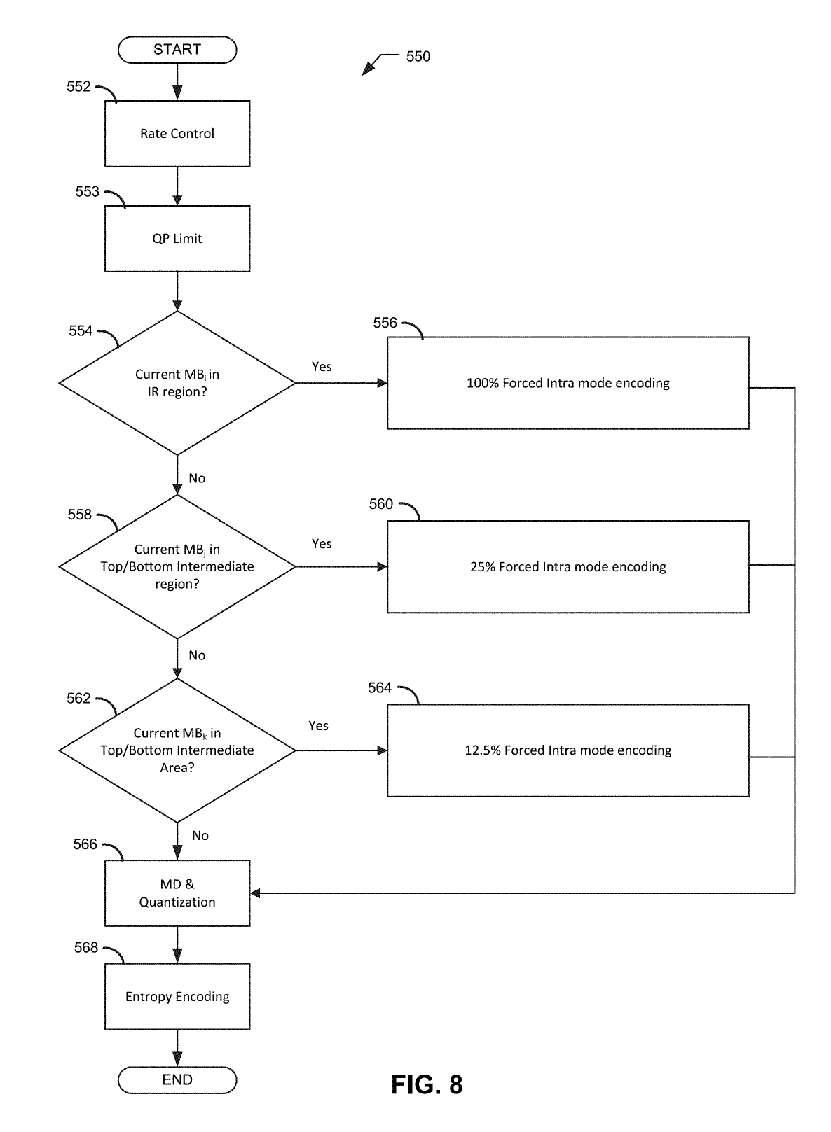

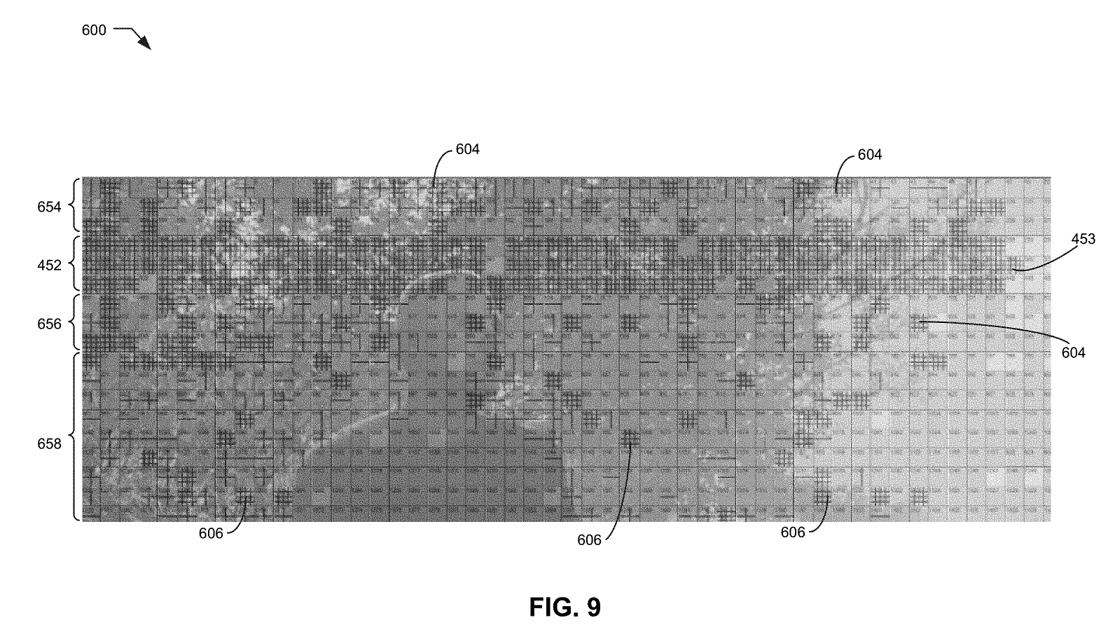

Techniques disclosed herein, including methods and apparatus, allow encoding of video data in a way to mitigate visible patterns from IDR macroblocks, such as those within IR regions of a video frame. Two techniques are introduced; the technique applies restrictions to limit variations in the quantization levels between different regions of the video frame. This first technique is described in most detailed with respect to FIGS. 6-7C. The second technique includes breaking the patterns of IDR type macroblocks by forcing IR macroblocks within random regions of a refreshed video frame. This second technique is described in most detailed with respect to FIGS. 8 and 9. In order to control the impact on the overall objective and subjective video image quality, the parameters of the two techniques may be programmable and adjusted to produce suitable results. The two techniques may be utilized individually or in combination.

Turning now to the drawings, and as described in detail below, one example of the presently disclosed system is a video encoder comprising an encoder with QP limiting logic and/or forced IR encoded macroblocks outside an IR region of a video frame.

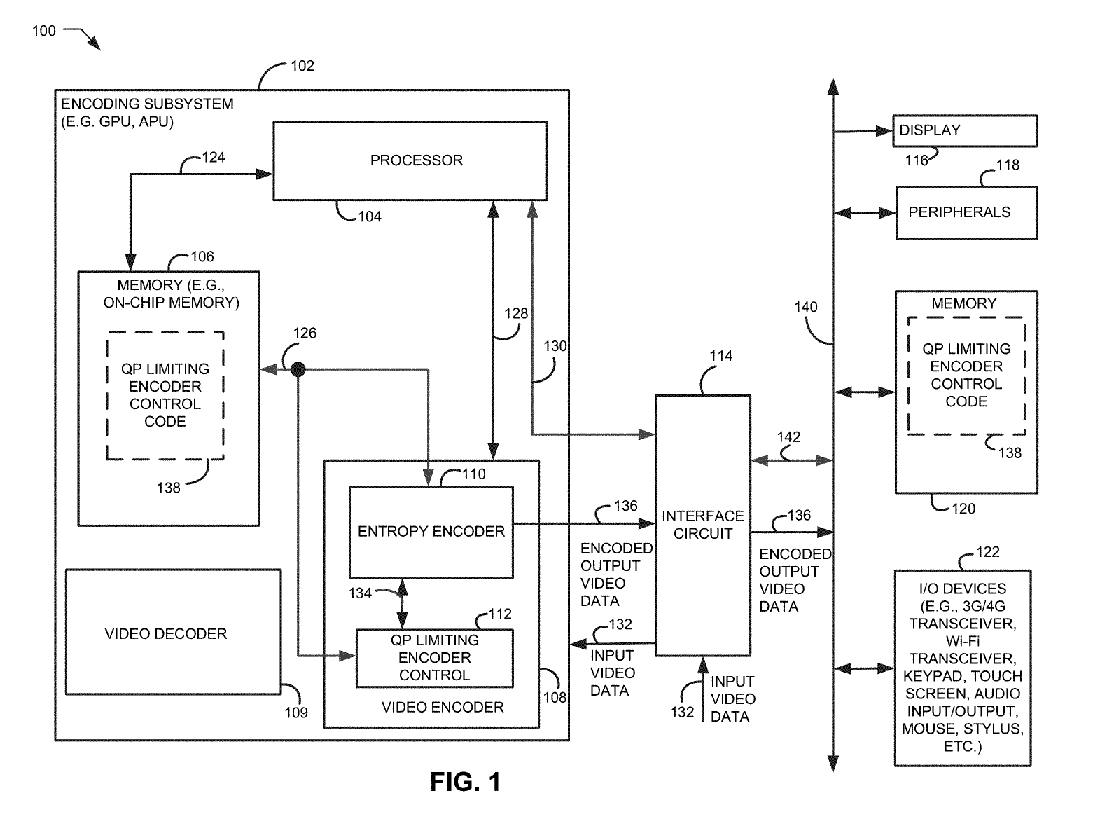

FIG. 1 is a functional block diagram illustrating an example apparatus 100 that includes encoding logic such as described above and in further detail below. The apparatus 100 may be, for example, any suitable device with video encoding capability such as, but not limited to, a mobile or smart phone, a phablet, a tablet, a laptop computer, a camera, portable media player, or any other suitable device including any suitable battery-equipped device, for example. More specifically, as illustrated in FIG. 1, the apparatus 100 includes an encoding subsystem 102, which includes a video encoder 108, a memory 106 such as on-chip memory, and a processor 104 such as a microcontroller or central processing unit (CPU). The video encoder 108 includes QP limiting encoder control logic 112 and entropy encoder 110. The memory 106 may communicate with, for example, processor 104 by way of communication link 124. For example, the memory may hold executable instructions, such as QP limiting encoder control code instructions, to be executed by processor 104. As will be appreciated, the video encoder 108 may also include the functionality of processor 104 in various embodiments of the present disclosure.

In some embodiments, encoding subsystem 102 may be an accelerated processing unit (APU), which may include one or more CPU cores or one or more general processing unit (GPU) cores on a same die. Alternatively, one or more of processor 104, memory 106, and video encoder 108 may include one or more digital signal processors (DSPs), one or more field programmable gate arrays (FPGAs), or one or more application-specific integrated circuits (ASICs). In some embodiments, some or all of the functions of processor 104, memory 106, and video encoder 108 may be performed by any suitable processors.

In some embodiments, some or all of the video encoder 108 including entropy encoder 110, QP limiting control logic 112, and any other logic described herein may be implemented by executing suitable instructions on, for example, processor 104 or any other suitable processor. In some examples, the executable suitable instructions may be stored on a computer readable storage medium, where the executable instructions are executable by one or more processors to cause the one or more processors to perform the actions described herein. In some embodiments, executable instructions may be stored on memory 106 or any other suitable memory that includes QP limiting encoder control code 138 that when accessed over communication link 124 and executed by processor 104 or any other suitable processor, control the video encoder 108 or parts thereof. For example, processor 104 may control the video encoding process by accessing the video encoder 108 over communication link 128. For example, video encoder 108 may include registers or other control mechanisms, such as within QP limiting control logic 112, that control some or all of the video encoding process. For example, communication link 134 may provide control information, data, or signals to the video encoder 108 to control the video encoding process. Some or all of this functionality may also be implemented in any other suitable manner such as but not limited to a software implementation, a firmware implementation, a hardware implementation, or any suitable combination of the example implementations described above.

As shown in FIG. 1, the encoding subsystem 102 may access input video data 132 containing video data to be encoded. In one embodiment, the video encoder 108 may receive the input video data 132 to be encoded. In another embodiment, the input video data 132 may be stored in memory 106 over communication link 126 or any other suitable communication link, for example, by the video encoder 108, and the encoding subsystem 102 may access input video data 132 stored in memory 106. In some embodiments, interface circuit 114 may receive input video data 132, which then provides input video data 132 to encoding subsystem 102, and the encoding subsystem 102 may access the input video data 132 received via interface circuit 114.

After the encoding process is performed, the video encoder 108 may generate encoded output video data 136 that may be provided to interface circuit 114. The interface circuit 114 may in turn provide encoded output video data 136 to expansion bus 140. The expansion bus 140 may further connect to, for example, a display 116; one or more peripheral devices 118; an additional memory 120 and one or more input/output (I/O) devices 122. The display 116 may be a cathode ray tube (CRTs), liquid crystal displays (LCDs), or any other type of suitable display. Thus, for example, after encoding the video data, the encoding subsystem 102 may provide the encoded output video data 136 for display on the display 116 and/or to any other suitable devices via, for example, the expansion bus 140. In some embodiments, the generated output video data 136 may be stored in memory, such as memory 106, additional memory 120, or any other suitable memory, to be accessed at a future time.

The encoding subsystem 102 may further include an optional video decoder 109. Video decoder 109 may be operable to decode video data, such as encoded output video data 136, received from external devices, such as the peripheral devices 118 and I/O devices 122. For example, especially with mobile devices, it may be necessary to both encode and decode video data with an APU, GPU, CPU or any other suitable integrated circuit(s) of the device.

In some embodiments, executable instructions that may include some or all of the video encoder 108, such as QP limiting control logic 112, and any other logic described herein may be stored in the additional memory 120 in addition to or instead of being stored in the memory 106. Additional memory 120 may also include, for example, QP limiting control code 138 that may be accessed by processor 104, or any other suitable processor, over communication link 130 to interface circuit 114. Interface circuit 114 allows access to expansion bus 140 over communication link 142, thus allowing processor 104 access to additional memory 120. The one or more I/O devices 122 may include, for example, one or more cellular transceivers such as a 3G, 4G or LTE transceiver, a WI-FI transceiver; a keypad, a touch screen, an audio input/output device or devices, a mouse, a stylus, a printer, and/or any other suitable input/output device(s).

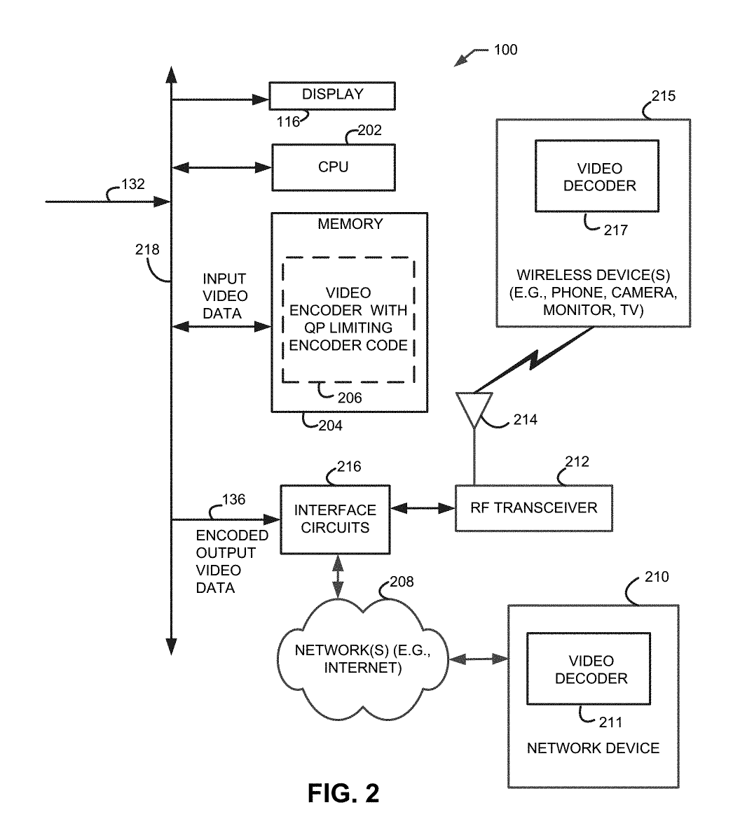

FIG. 2 is a functional block diagram of another embodiment of an example apparatus 100 that includes CPU 202 and memory 204. The memory 204 may store executable instructions including video encoder with QP limiting control logic 206 that when executed by the CPU 202 perform some or all of the functions of the video encoder 108 of FIG. 1. For example, the CPU 202 may execute instructions, including the video encoder with QP limiting control logic 206. The CPU 202 may receive the input video data 132 via the expansion bus 218, perform the aforementioned processing, and provide the encoded output video data 136 to interface circuits 216. The interface circuits 216 may be operatively coupled to one or more networks 208, such as, for example, the Internet, and may also be operatively coupled to one or more RF transceiver 212. Thus, via the interface circuits 216, the encoded output video data 136 may be provided to either local or remote devices. For example, network device 210 may receive the encoded output video data 136 via network 208. Network device 210 includes one or more video decoders 211 operable to decode the encoded output video data 136. Similarly, one or more wireless devices 215, including one or more video decoders 217 operable to decode the encoded output video data 136, may receive encoded output video data 136 via a transmission from antennae 214, which is operatively coupled to RF transceiver 212.

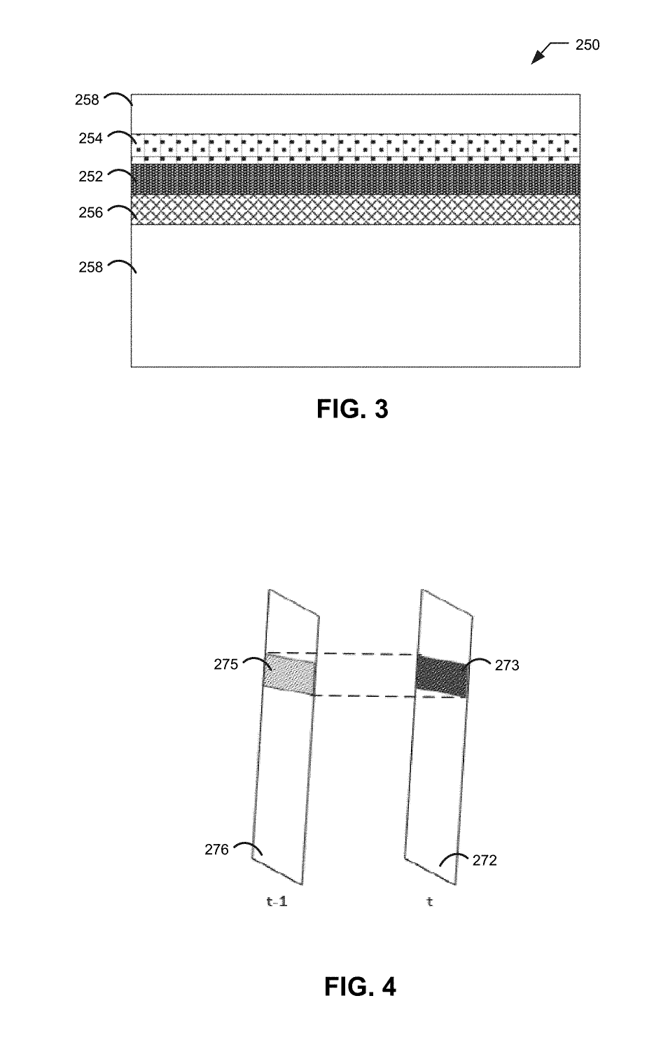

FIG. 3 is a conceptual illustration of a row-based IR region 252 of video frame 250 surrounded by top intermediate area 254 and bottom intermediate area 256 in the non-IR region of video frame 250. Areas 258 represent the remaining areas of video frame 250 in the non-IR region of video frame 250 outside IR region 252 and top and bottom intermediate areas 254, 256. FIG. 4 is a conceptual illustration of a row-based IR region 273 of a video frame 272 and a co-located region 275 of a neighboring video frame 276 in a temporal domain. Video frame 276 is a neighboring video frame in a temporal domain to video frame 272 as it is either adjacent in a temporal domain to video frame 272 or at least includes video data suitable to support inter prediction encoding of at least some units, such as macroblocks, of video frame 272 based on the video data of video frame 276.

When row or column based IR is enabled, through IDR video units, such as macroblocks forming IR region 252, the IR region may be visible in a video as a belt shaped flicker moving from the top of the frame to bottom for the row based IR or from the left to the right for the column based IR. This scanning flicker may be perceived as a visible artifact, especially when input video content containing fine granular texture is encoded with relatively high QP, i.e., lower bit rate. The scanning flicker may be caused by different quantization effect on the DCT coefficients of residue resulted from different prediction modes, such as IR and inter prediction modes. The scanning flicker may also be caused by different QPs between IR and non-IR regions in spatial domain, such as IR region 252 and areas 254, 256, 258 of the non-IR region of video frame 250, and that of two co-located macroblocks in neighboring frames in the temporal domain, such as IR region 273 of video frame 272 and co-located region 275 of video frame 276 (FIG. 4).

In the temporal domain, between two neighboring frames, such as video frames 272, 276, when two co-located macroblocks, such as co-located macroblocks within IR region 273 of video frame 272 and co-located region 275 of video frame 276, are encoded in different prediction modes, the reconstructed version of those two co-located macroblocks look different. In spatial domain, the boundary between rows/columns based IR region and non-IR region can be observed. These visual difference may be annoying to a viewer when the input video with complex texture is encoded with relatively high QP.

In the encoding process of a hybrid video encoder providing for both IR encoding and inter prediction encoding, before quantization, the distribution of DCT coefficients generated from IR and inter prediction prediction are different. So even using the same QP, a different amount of quantization noise can be introduced. When this noise forms patterns, due to IDR type macroblocks for example, it may also contribute to undesirable visual artifacts in the encoded video stream.

Besides the impact from various prediction modes, such as IR and inter prediction, the QP difference in spatial and temporal domains bring not only different quantization effect but unequal values for loop filter parameters, and in turn different extent of smoothing on reconstructed picture which may amplify visual artifacts between IR and non-IR regions.

As discussed in further detail below, top intermediate area 254 and bottom intermediate area 256 may be utilized to mitigate visual artifacts from IR region 252. For example, as described in more detail with respect to FIGS. 6-7C, quantization levels within IR region 252 may be limited according to the quantization levels of top intermediate area 254 and co-located region 275 of video frame 276 (FIG. 4).

As another example, as described in more detail with respect to FIGS. 8 and 9, a proportion of macroblocks within the non-IR regions of video frame 250 may be forced IR macroblocks to break-up patterns along the boundaries between IR region 252 and the non-IR regions of video frame 250. For example, a proportion of macroblocks within top intermediate area 254 and bottom intermediate area 256 may be forced IR macroblocks to break-up patterns along the boundaries between IR region 252 and top and bottom intermediate areas 254, 256. In some examples, a proportion of macroblocks within area 258 may also represent forced IR macroblocks. In some examples, top intermediate area 254 and bottom intermediate area 256 may include a higher proportion of forced IR macroblocks than in remaining areas 258.

As discussed in further detail below, co-located region 275 may be utilized to mitigate visual artifacts from IR region 273. For example, as described in more detail with respect to FIGS. 6-7C, quantization levels within IR region 273 may be limited according to the quantization levels of co-located region 275. In some example, quantization levels within an IR region, such as IR region 273 or IR region 252 (FIG. 3), may be limited according to the quantization levels of a co-located region, such as co-located region 275, and areas of the non-IR region, such as top intermediate area 254 (FIG. 3) and bottom intermediate area 256 (FIG. 3).

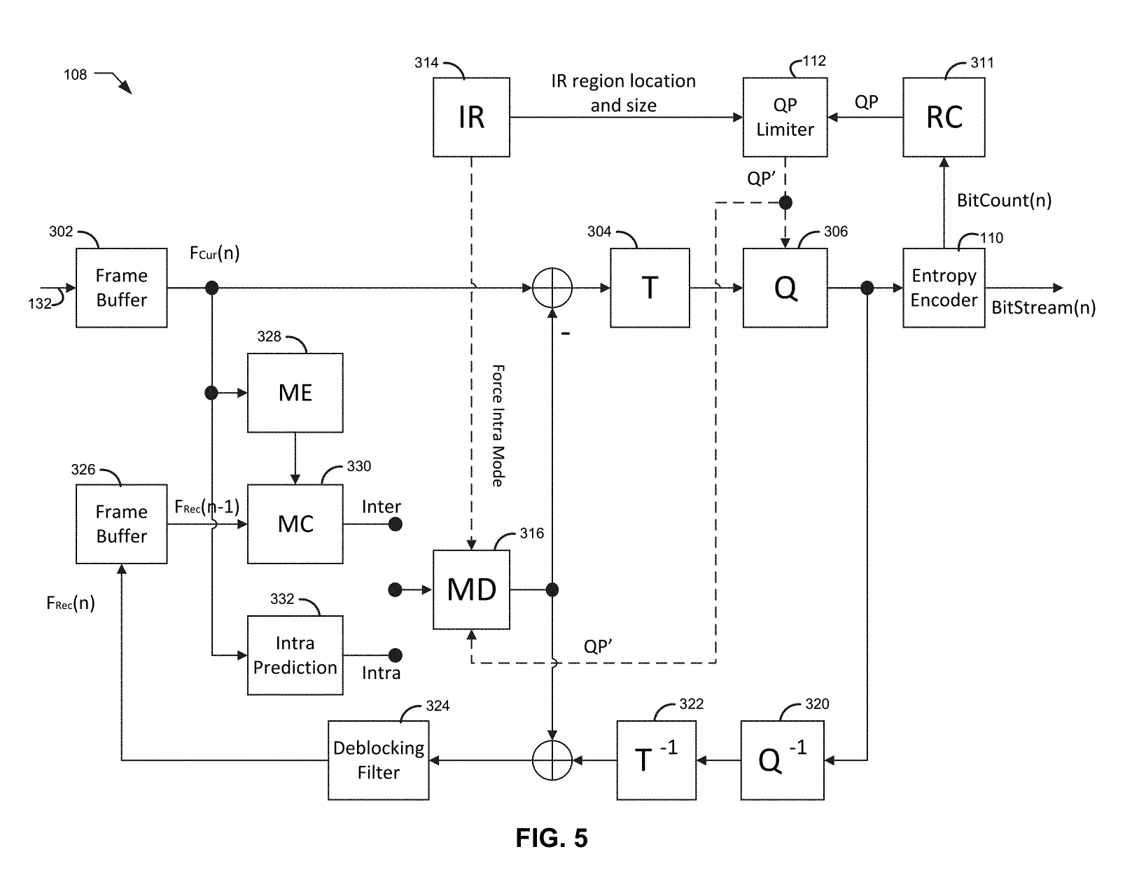

FIG. 5 is a functional block diagram illustrating an example of further detail of the operation of video encoder 108 with QP limiting control logic 112. The video encoder 108 with QP limiting control logic 112 accesses video information including input video data 132. Accessing the video information may include either requesting or retrieving the video information either from memory or another component, such as an external device, or simply receiving the video information from another component, such an external device, without first requesting it. The video encoder 108 with QP limiting control logic 112 may process the input video data 132 according to various stages of video processing. For example, the input video data may first enter frame buffer 302. Frame buffer 302 may temporarily store a plurality of video frames to facilitate IR encoding.

Video encoder 108 includes DCT control logic 304, which transfers video information from the special domain to the frequency domain and calculates coefficients of residue based on the video information from frame buffer 302. DCT control logic 304 may be applied to both IR encoded video units and inter prediction encoded video units or only to IR encoded video units as well as the selected encoding mode (IR encoding or inter prediction encoding) from mode decision control logic 316. Quantization control logic 306 receives video information with DCT coefficients from DCT control logic 304, and drops input video information based on the QP′ value received from QP limiting control logic 112. The QP′ value for each unit may be based on a QP valuation determined by the rate control logic 311, as limited by QP limiting control logic 112. As discussed in further detail with respect to FIGS. 6-7C, QP limiting control logic 112 may restrict QPs within an IR region based on quantization levels of a co-located region in a temporally adjacent video frame, such as co-located region 275 (FIG. 4), and/or top and/or bottom intermediate areas of the same video frame, such as intermediate areas 254, 256 (FIG. 3). For each unit, such as a macroblock, the entropy encoder 110 receives the video information, the mode decision information indicating IR encoding or inter prediction encoding, and the QP value for the unit. The entropy encoder 110 then encodes the video information of the video unit, such as a macroblock, according to these parameters, and outputs the encoded video information as a bitstream.

As shown in FIG. 5, a number of the parameters provided to the entropy encoder 110 are based on information from additional units, such as a macroblocks, and temporally adjacent video frames. For each video unit, such as each macroblock, the entropy encoder 110 outputs a bitcount to the rate control logic 311. The rate control logic 311 calculates a QP value for additional units, such as macroblocks, based on the bitcounts of other units, including units within a video frame and within temporarily adjacent video frames. The QP values calculated by the rate control logic 311 facilitate encoding according to a desired or available bandwidth for the bitstream. The QP value from the rate control logic 311 is sent to QP limiting control logic 112, which may modify the QP value for units within an IR region based on quantization levels of a co-located region in a temporally adjacent video frame, such as co-located region 275 (FIG. 4), and/or top and/or bottom intermediate areas of the same video frame, such as intermediate areas 254, 256 (FIG. 3). In examples in which the QP value from rate control logic 311 is within the prescribed limits, the QP′ value output of QP limiting control logic 112 may equal the QP value from rate control logic 311.

The video information from the quantization control logic 306, which has been reduced based on the QP′ value from QP limiting control logic 112 is also redirected to facilitate inter prediction encoding. Specifically, the inverse quantization control logic 320 may perform the reverse process of the quantization control logic 306. The output of the inverse quantization control logic 320 will not include more information than the output of the quantization control logic 306. Since the quantization control logic 306 resulted in information loss of the input video signal, the output of the inverse quantization control logic 320 will also represent less information than the input video data 132. The output of the inverse quantization control logic 320 is directed to the inverse DCT control logic, which transforms the signal from the frequency domain into the spatial domain of the input video data 132 to produce a reconstructed frame. The reconstructed frame includes a lot of artifacts, some of which are mitigated through the deblocking filter 324. The output of deblocking filter 324 is directed to frame buffer 326, which is directed to motion compensation control logic 330 to allow comparison within an input video unit from the input video data 132 via motion estimation control logic 328 for inter prediction encoding. Motion estimation control logic 328 may utilize matching motion estimation, integer motion estimation, fractional motion estimation or other inter prediction encoding techniques.

Mode decision control logic 316 evaluates whether inter prediction encoding or intra prediction coding is more suitable for each video unit; however, IDR type video units, within an IR region for example, as indicated by IR control logic 314 are forced IR macroblocks, i.e., automatically encoded using IR encoding techniques. In addition, as described in more detail with respect to FIGS. 8 and 9, a proportion of units outside an IR region may also be forced IR macroblocks in order to soften the visual differences between the IR region and areas of a video frame outside the IR region.

FIG. 6 is a flowchart of an example method 350 for encoding video data while limiting QP to mitigate visual artifacts in the encoded video data. Some or all of the disclosed steps may be embodied within video encoder 108 including QP limiting control logic 112. The method illustrated in FIG. 6, and each of the example methods described herein, may be carried out by one or more suitably programmed controllers or processors executing software, for example, by processor 106 executing suitable instructions. The method may also be embodied in hardware or a combination of hardware and hardware executing software. Suitable hardware may include one or more ASICs, state machines, FPGAs, DSPs, and/or other suitable hardware. Although the method(s) is/are described with reference to the illustrated flowcharts (such as shown in FIGS. 6 and 8), it will be appreciated that many other ways of performing the acts associated with the method(s) may be used. For example, the order of some operations may be changed, and some of the operations described may be optional. Additionally, while the method(s) may be described with reference to the example apparatus 100, it will be appreciated that the method(s) may be implemented by other apparatus as well, and that the apparatus 100 may implement other methods.

FIG. 7A illustrates video frame 450 including an IR region 452. FIG. 7B illustrates the video frame 450 with QP values selected without limiting QP, whereas FIG. 7C illustrates the image of the video frame 450 in a video frame 460 encoded while limiting QP to mitigate visual artifacts according to the techniques of FIG. 6. The encoding techniques used to form video frame 450 in FIG. 7B may be embodied in a video encoder similar to video encoder 108, but without QP limiting control logic 112, whereas as the encoding techniques used to form video frame 450 in FIG. 7C may be embodied in a video encoder similar to video encoder 108 including QP limiting control logic 112.

In FIG. 7A, macroblocks with IR encoding include cross-hatching, such as example IDR type macroblock 453, whereas macroblocks with inter prediction encoding do not include cross hatching. Macroblocks within IR region 452 are predominantly IR encoded, and macroblocks outside IR region 452 are predominantly inter prediction encoded. QP values for each of the macroblocks of video frame 450 are illustrated in FIG. 7B. Areas 458 represent non-IR regions of video frame 450.

As shown in FIG. 7B, video frame 450 includes macroblocks with QP values as high as thirty (30) in IR region 452 adjacent to macroblocks with QP values as low as twenty-six (26) in non-IR regions of video frame 450. This difference in QP values may contribute to a noticeable artifact between the IR region 452 and the non-IR regions of video frame 450.

As shown in FIG. 7C, video frame 460 includes row-based IR region 452 surrounded by top intermediate area 454 and bottom intermediate area 456. The height of top intermediate area 454 and bottom intermediate area 456 can be configurable, for example 48 pixels. Areas 458 represent the remaining areas of video frame 460. Areas 454, 456 and 458 represent non-IR regions of video frame 460.

In contrast to video frame 450 of FIG. 7B, video frame 460 of FIG. 7C includes macroblocks with QP values as no higher than twenty-nine (29) in IR region 452 adjacent to macroblocks with QP values no lower than twenty-eight (28) in non-IR regions of video frame 450. The QP values indicated in the macroblocks of video frame 460 may have been set by QP limiting control logic 112 to limit noticeable artifacts between the IR region 452 and the non-IR regions of video frame 460.

For clarity, the techniques of FIG. 6 are described in further detail with respect to video encoder 108 including QP limiting control logic 112 and video frame 460 of FIG. 7C. The example method 350 begins at block 352 where rate control logic 311 calculates a QP value for a macroblock to facilitate encoding according to a desired or available bandwidth for a bitstream. The QP value is sent to QP limiting control logic 112, which may limit the QP value to reduce visual artifacts in the encoded video.

As represented by blocks 354, 358, and 362, the QP values from rate control logic 311 are analyzed according to the positions of the corresponding macroblocks. According to blocks 354, 356, QP values for macroblocks within top intermediate area 454 (FIG. 7C) are collected to calculate the range of QP values within the top intermediate area 454. Thus, in this example, the QP′ values for macroblocks within top intermediate area 454 from QP limiting control logic 112 are the same as the QP values from rate control logic 311.

According to blocks 358, 360, QP limiting control logic 112 may modify the QP value of a macroblock within the IR region 452 calculated by the rate control logic 311 to produce a QP′ value actually used in the encoding of the macroblock. The QP′ values for macroblocks within IR region 452 (FIG. 7C) may be limited based on the range of QP values within the top intermediate area 454 and/or based on quantization levels of a co-located region in a temporally adjacent video frame. In the specific example of FIG. 6, the QP distribution in IR region 452 is restricted in the range of [max(minQP_{Top}−1, minQP_{co}−1), min(maxQP_{Top}+1, maxQP_{co}+1], where minQP_{Top} and maxQP_{Top} are the min/max QP of top intermediate area 454 in the same frame while minQP_{Co} and maxQP_{Co} are the max/min QP of co-located IR region in temporally adjacent frame, such as the immediately prior frame.

Similarly, according to blocks 362, 364, QP′ values for macroblocks within bottom intermediate area 456 (FIG. 7C) are limited based on the range of QP′ values within the IR region 452. In one specific example, the QP′ values for macroblocks within bottom intermediate area 456 may be restricted in the range of [minQP_{IR}−1, maxQP_{IR}+1], where minQP_{IR} and maxQP_{IR} are the max/min QP′ of IR region 452.

FIG. 8 is a flowchart of an example method 550 for encoding video data while forcing IR encoding in areas outside an IR region of a video frame to mitigate visual artifacts in the encoded video data. FIG. 9 illustrates a video frame 600 encoded while forcing IR encoding in areas outside IR region 452 according to the techniques of FIG. 8.

For clarity, the techniques of FIG. 8 are described in further detail with respect to video encoder 108 including QP limiting control logic 112 and video frame 600 of FIG. 9. The example method 550 begins at block 552 where rate control logic 311 calculates a QP value for a macroblock to facilitate encoding according to a desired or available bandwidth for a bitstream. At block 553, the QP value is optionally, sent to QP limiting control logic 112, which may limit the QP value to reduce visual artifacts in the encoded video, for example, as described with respect to method 350 of FIG. 6.

In addition to, or as an alternative to, limiting the QP value to reduce visual artifacts in the encoded video using QP limiting control logic 112, IR control logic 314 of video encoder 108 may force IR encoding on macroblocks outside IR region 452 of video frame 600 to further mitigate visual artifacts in the encoded video data.

As shown in FIG. 9, macroblocks with IR encoding include cross-hatching, such as example IDR type macroblock 453, whereas macroblocks with inter prediction encoding do not include cross hatching. Macroblocks within IR region 452 are predominantly IR encoded, and macroblocks outside IR region 452 are include a greater proportion of inter prediction encoded macroblocks. For example, top and bottom intermediate areas 654, 656 includes some IR encoded macroblocks, such as example macroblocks 604. The remaining non-IR region of video frame 600 represents area 658, which also includes some IR encoded macroblocks, such as example macroblocks 606.

As represented by blocks 554, 556, IR control logic 314 forces all or predominant proportion of macroblocks within IR region 452 to be IR encoded. Moreover, IR control logic 314 may further randomly introduce IR encoded macroblocks within non-IR regions of video frame 600, including top and bottom intermediate areas 654, 656 and well as the remaining area 658 of the non-IR regions of video frame 600 in order to relieve the belt shaped visual difference between IR encoded macroblocks and inter prediction encoded macroblocks (basically, to break the pattern).

In a specific example, as represented by blocks 558, 560, IR control logic 314 may force a distributed minority, such as about twenty-five percent (25%), of macroblocks within the top and bottom intermediate areas 654, 656 to be IR encoded. In the same or different example, as represented by blocks 562, 564, IR control logic 314 may force a distributed minority, such as the same or less proportion as with the top and bottom intermediate areas 654, 656, such as about twelve and-a-half percent (12.5%), of macroblocks within the remaining non-IR region of video frame 600, area 658, to be IR encoded. In this manner, macroblocks within the remaining non-IR region of video frame 600, area 658, may be predominately inter prediction encoded with a higher proportion of inter prediction encoded macroblocks than within the top and bottom intermediate areas 654, 656.

Human eyes are more sensitive to some kind of pattern in video rather than random noise such that randomly introducing IR encoded macroblocks within the non-IR region reduces visual artifacts in the encoded video stream caused by the IDR type macroblocks of IR region 452.

In various examples, the probability in which the macroblocks within top and bottom intermediate areas 654, 656 the remaining non-IR region of video frame 600, area 658, to be IR encoded can be controlled. In order to achieve the random distribution of forced IR encoded macroblocks, in one specific example, multiple bit fields of the cycle count value can be used to select macroblocks for forced IR encoding. For example, a macroblock could be selected for forced IR encoding with roughly a twenty-five percent (25%) probability if the last two bits of cycle count value are ‘0x11’. Of course other selection techniques are also possible.

Different probabilities for forced IR encoding of macroblocks within top and bottom intermediate areas 654, 656 the remaining non-IR region of video frame 600, area 658, can be and configurable with IR control logic 314 of video encoder 108.

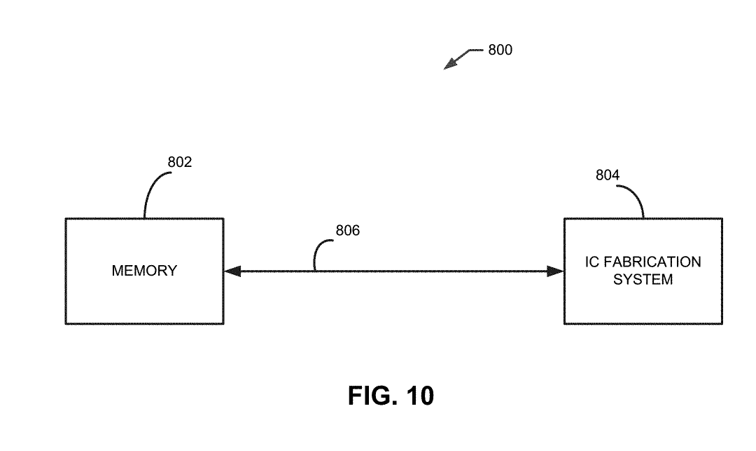

Referring to FIG. 10, an integrated circuit fabrication system 804 is shown which may include memory 802 that may be accessed via communication link 806, which may be in any suitable form and any suitable location accessible via the web, accessible via hard drive, or any other suitable way. The memory 802 is a non-transitory computer readable medium such as but not limited to RAM, ROM, and any other suitable memory. The IC fabrication system 804 may be one or more work stations that control a wafer fabrication to build integrated circuits. The memory 802 may include thereon instructions that when executed by one or more processors causes the integrated circuit fabrication system 804 to fabricate one or more integrated circuits that include the logic and structure described herein.

The disclosed integrated circuit designs may be employed in any suitable apparatus including but not limited to, for example, a mobile or smart phone, a phablet, a tablet, a camera, a laptop computer, a portable media player, a set-top box, a printer, or any other suitable device which encodes or plays video and/or displays images. Such devices may include, for example, a display that receives image data, such as image data that has been processed in the manner described herein, including the encoded output vide data 136, from the one or more integrated circuits where the one or more integrated circuits may be or may include, for example, an APU, GPU, CPU or any other suitable integrated circuit(s) that provide(s) image data for output on the display. Such an apparatus may employ one or more integrated circuits as described above including one or more of the encoder with QP limiting control logic, and other components described above.

Also, integrated circuit design systems, such as work stations including, as known in the art, one or more processors, associated memory in communication via one or more buses or other suitable interconnect and other known peripherals, are known that create wafers with integrated circuits based on executable instructions stored on a computer readable medium such as but not limited to CDROM, RAM, other forms of ROM, hard drives, distributed memory, etc. The instructions may be represented by any suitable language such as but not limited to hardware descriptor language (HDL), Verilog, or other suitable language. As such, the logic and structure described herein may also be produced as one or more integrated circuits by such systems using the computer readable medium with instructions stored therein. For example, one or more integrated circuits with the logic and structure described above may be created using such integrated circuit fabrication systems. In such a system, the computer readable medium stores instructions executable by one or more integrated circuit design systems that causes the one or more integrated circuit design systems to produce one or more integrated circuits. For example, the one or more integrated circuits may include one or more of the encoder with QP limiting control logic, and any other components described above that process video data in a way that reduces subjective visual artifacts, as described above.

Among other advantages, for example, the disclosed methods and apparatus allow video encoding that reduces subjective visual artifacts, such as flicker, caused by IDR type macroblocks and in turn subjective video quality can be improved. Other advantages will be recognized by those of ordinary skill in the art.

The above detailed description and the examples described therein have been presented for the purposes of illustration and description only and not for limitation. For example, the operations described may be done in any suitable manner. It is therefore contemplated that the present embodiments cover any and all modifications, variations or equivalents that fall within the scope of the basic underlying principles disclosed above and claimed herein. Furthermore, while the above description describes hardware in the form of a processor executing code, hardware in the form of a state machine or dedicated logic capable of producing the same effect, other structures are also contemplated.

What is claimed is:

1. A method of encoding video data, comprising:
accessing video information; and
encoding macroblocks in an intra refresh (IR) region of a video frame of the video information with restricted quantization parameters (QPs) based on QPs of macroblocks within at least one of a non-IR region of the video frame, and a co-located region of a neighboring video frame in a temporal domain.

2. The method of claim 1, wherein the restricted QPs of the macroblocks in the IR region are limited to a range of QPs that partially overlaps a range of QPs of the macroblocks within at least one: of the non-IR region of the video frame and the co-located region of the neighboring video frame in the temporal domain.

3. The method of claim 1, wherein:
the restricted QPs of the macroblocks in the IR region are based on QPs of an intermediate area in the non-IR region of the video frame, and
the intermediate area of the video frame is adjacent to the IR region of the video frame.

4. The method of claim 3, wherein:
the intermediate area of the video frame is a first intermediate area adjacent a first side of the IR region of the video frame, the video frame further including a second intermediate area in the non-IR region of the video frame adjacent a second side of the IR region of the video frame, and
the restricted QPs of the macroblocks in the IR region are based on QPs the first intermediate in the non-IR region of the video frame and the second intermediate in the non-IR region of the video frame.

5. The method of claim 3, wherein the video frame includes the IR region of the video frame, the intermediate area in the non-IR region of the video frame adjacent the IR region of the video frame, and remaining portions of the non-IR region of the video frame.

6. The method of claim 1, wherein the restricted QPs of the macroblocks in the IR region are based on QPs of the co-located region of the neighboring video frame in the temporal domain.

7. The method of claim 1, wherein:
the restricted QPs of the macroblocks in the IR region are based on QPs of the co-located region of the neighboring video frame in the temporal domain, and further based on QPs of the non-IR region of the video frame, and
the non-IR region of the video frame is adjacent to the IR region of the video frame.

8. The method of claim 1, wherein the video frame includes the IR region of the video frame, a first intermediate area adjacent a first side of the IR region of the video frame, a second intermediate area in the non-IR region of the video frame adjacent a second side of the IR region of the video frame, and remaining portions of the non-IR region of the video frame, the method further comprising:
encoding a majority of macroblocks in the first and second intermediate areas of the non-IR region of the video with inter prediction encoding while forcing IR encoding on a distributed minority of the macroblocks; and
encoding a majority of macroblocks in the remaining portions of the non-IR region of the video frame predominately with inter prediction encoding while forcing IR encoding on a distributed minority of the macroblocks.

9. The method of claim 8, wherein encoding macroblocks in the first and second intermediate areas includes forcing IR encoding on a greater proportion of the macroblocks than when encoding macroblocks in the remaining portions of the non-IR region of the video frame.

10. The method of claim 1, wherein:
the macroblocks of the IR region are instantaneous decoder refresh type macroblocks, and
the IR region is a row or column band within the video frame.

11. An apparatus for encoding video data, the apparatus comprising a video encoder logic structured to:
access video information; and
encode instantaneous decoder refresh (IDR) type macroblocks in an intra refresh (IR) region of a video frame with restricted quantization parameters (QPs) based on QPs of macroblocks within at least one of a non-IR region of the video frame, and a co-located region of a neighboring video frame in a temporal domain.

12. The apparatus of claim 11, further comprising memory that stores the video information, the video information including a current frame and a neighboring video frame in a temporal domain.

13. The apparatus of claim 11, wherein the video encoder logic is further structured to limit restricted QPs of the IDR type macroblocks to a range of QPs that partially overlaps a range of QPs of the macroblocks within the at least one of the non-IR region of the video frame and the co-located region of the neighboring video frame in the temporal domain.

14. The apparatus of claim 11, wherein:
the video encoder logic is further structured to limit restricted QPs of the IDR type macroblocks based on QPs of an intermediate area in the non-IR region of the video frame, and
the intermediate area of the video frame is adjacent to the IR region of the video frame.

15. The apparatus of claim 14, wherein the intermediate area of the video frame is a first intermediate area adjacent a first side of the IR region of the video frame, the video frame further including a second intermediate area in the non-IR region of the video frame adjacent a second side of the IR region of the video frame.

16. The apparatus of claim 11, wherein the video encoder logic is further structured to limit restricted QPs of the IDR type macroblocks based on QPs of the co-located region of the neighboring video frame in the temporal domain.

17. The apparatus of claim 11, wherein:
the video encoder logic is further structured to limit restricted QPs of the IDR type macroblocks based on QPs of the co-located region of the neighboring video frame in the temporal domain, and further based on QPs of the non-IR region of the video frame, and
the non-IR region of the video frame is adjacent to the IR region of the video frame.

18. The apparatus of claim 11, wherein the video frame includes the IR region of the video frame, a first intermediate area adjacent a first side of the IR region of the video frame, a second intermediate area in the non-IR region of the video frame adjacent a second side of the IR region of the video frame, and remaining portions of the non-IR region of the video frame, wherein the video encoder logic is further structured to:
encode macroblocks in the first and second intermediate areas of the non-IR region of the video frame predominately with inter prediction encoding while forcing IR encoding on a distributed minority of the macroblocks; and
encode macroblocks in the remaining portions of the non-IR region of the video frame predominately with inter prediction encoding while forcing IR encoding on a distributed minority of the macroblocks,
wherein the video encoder logic is further structured to encode macroblocks in the first and second intermediate areas includes forcing IR encoding on a greater proportion of the macroblocks than when encoding macroblocks in the remaining portions of the non-IR region of the video frame.

19. The apparatus of claim 11, further comprising at least one of an accelerated processing unit (APU), a central processing unit (CPU), and a graphics processing unit (GPU), wherein:
the at least one of the APU, the CPU, and the GPU includes the video encoder logic, and
the at least one of the APU, the CPU, and the GPU is operative to provide the encoded video data for display on a display.

20. A non-transitory computer readable medium comprising executable instructions that when executed cause an integrated circuit (IC) fabrication system to fabricate one or more ICs that comprise:
a video encoder logic structured to:
access video information; and
encode instantaneous decoder refresh (IDR) type macroblocks in an intra refresh (IR) region of a video frame with restricted quantization parameters (QPs) based on QPs of macroblocks within at least one of a non-IR region of the video frame, and a co-located region of a neighboring video frame in a temporal domain.
